(19) United States
(12) Patent Application Publication
(10) Pub. No.: US 2017/0009128 A1
(43) Pub. Date: Jan. 12, 2017

(54) METHODS FOR ENHANCING OIL RECOVERY USING COMPLEX NANO-FLUIDS

(71) Applicant: the University of Wyoming, Laramie, WY (US)

(72) Inventor: Brian Francis Towler, Taringa (AU)

(21) Appl. No.: 15/205,222

(22) Filed: Jul. 8, 2016

Related U.S. Application Data
(60) Provisional application No. 62/189,895, filed on Jul. 8, 2015.

(51) Int. Cl. C09K 8/584; E21B 43/17; C09K 8/58

(52) U.S. Cl. CPC C09K 8/584; C09K 8/58; E21B 43/17; C09K 2208/10; E21B 43/26

(57) ABSTRACT

The inventions described herein relate generally to novel methods for increasing oil extraction using complex nano-fluids and, in at least one embodiment, to a method of increasing the recovery during oil extraction by injecting complex nano-fluids into an injection well in order to increase oil production yields.

This application claims priority to U.S. Patent Application 62/189,895, filed Jul. 8, 2015, which is incorporated herein in its entirety by this reference.

### BACKGROUND OF THE INVENTION

The increase in world-wide energy consumption has resulted in an escalated demand for hydrocarbons. As known conventional reservoirs are depleted, the need and desire for unconventional production methods and enhanced recovery processes has intensified. One important method of increasing recovery from oil reservoirs is through the use of surfactants. However, even with surfactants the recovery factor from many conventional oil reservoirs by primary and secondary means rarely exceeds 50%. The recovery sometimes results from simulation being restricted to a single well. Conventional processes attempt to improve the flow of oil from a particular well by injecting acids, surfactants, and fracking fluids into a single well and then flowing the formation fluids back from that same well.

Capillary forces can be an even greater inhibitor of oil recovery. Capillary forces result from interfacial forces between the oil, water, and rock. This is characterized by the oil/water interfacial tension and the rock's angle of wettability. One important method of reducing the capillary force, and thereby increasing the recovery from oil reservoirs, is through the use of surfactants which reduce surface tension and contact angles. The addition of solvents can also clean capillary walls, changing the wetting of the matrix. Complex nano-fluids have been used in applications such as well cleaning and as a drilling fluid, fracture fluid, or acid fluid additive; however prior to the inventor's discovery there was no method for decreasing capillary forces in order to enhance oil recovery.

### BRIEF SUMMARY OF THE INVENTION

While the use of surfactants can increase oil extraction, the recovery factor achieved by conventional methods rarely exceeds 50%. Thus, there is a need in the art for a more effective method for oil extraction. The invention described herein relates to a method for injecting complex nano-fluids to recover oils of the type found in producing reservoirs that results in an enhanced recovery process at conditions currently experienced in conventional methods of oil recovery. Another aspect of the present invention relates to reducing capillary forces in an oil recovery process.

### BRIEF DESCRIPTION OF THE DRAWINGS

FIG. 1 depicts a method for oil recovery by injecting CnFs into a series of injection wells and sweeping the oil toward a production well.

FIG. 2 depicts cumulative oil recovery for primary and enhanced imbibitions of the Tensleep cores.

FIG. 3 depicts cumulative oil recovery using pumice cores.

FIG. 4 depicts cumulative oil recovery using Tensleep (sandstone/dolomite) cores.

### DETAILED DESCRIPTION OF THE INVENTION

The inventions described herein relate generally to a method for increased oil extraction and, more specifically, to a method of increasing the recovery during oil extraction where the complex nano-fluid (CnF) is injected into an injection well in order to increase the yield in an oil production well.

To facilitate understanding of the disclosure, the following definitions are provided: As used herein, the term complex nano-fluid (CnF) may refer to a variety of different CnF's. In one embodiment, the CnF is obtained from CESI Chemical, a Flotek Industries company. The CnF contains citrus terpene, isopropyl alcohol, a surfactant, and water to create a specially engineered nano-fluid. The CnF is designated by CESI as MA-844W, which is described in U.S. Pat. No. 7,380,606, issued on Jun. 3, 2008 (the '606 Patent), which is expressly incorporated herein by reference. The compound is biodegradeable and thermodynamically stable, and consists of a micro-emulsion of a non-ionic surfactant (e.g. polyoxyethylene sorbitan monopalmitate), a solvent (e.g. citrus terpene d-limonene), water, and a co-solvent alcohol (e.g. isopropanol). Prior to the surprising discovery disclosed herein, the CnF was designed and has been used as a stimulation additive and/or a fracture fluid additive.

In alternate embodiments, the term CnF may refer generally to a CnF with a similar formulation as the CnF described in the '606 Patent that shows the same propensity for enhanced oil recovery, including those compounds that would be considered suitable for these application by those skilled in the art.

As used herein, the singular forms “a,” “an,” and “the” include plural referents unless the context clearly dictates otherwise. Thus, for example, reference to “a factor” refers to one or mixtures of factors, and reference to “the method of treatment” includes reference to equivalent steps and methods known to those skilled in the art, and so forth.

Where ranges are used in this disclosure, the end points only of the ranges are stated so as to avoid having to set out at length and describe each and every value included in the range. Any appropriate intermediate value and range between the recited endpoints can be selected. By way of example, if a range of between 0.1 and 1.0 is recited, all intermediate values (e.g., 0.2, 0.3. 6.3, 0.815 and so forth) are included as are all intermediate ranges (e.g., 0.2-0.5, 0.54-0.913, and so forth).

Before explaining the various embodiments of the disclosure, it is to be understood that the invention is not limited in its application to the details of construction and the arrangement of the components set forth in the following description. Other embodiments can be practiced or carried out in various ways. Also, it is to be understood that the phraseology and terminology employed herein is for the purpose of description and should not be regarded as limiting the inventions described in any way.

As described herein, one aspect of the present invention includes a method to enhance or improve the recovery during oil extraction, comprising administering an efficacious amount of a CnF to an injection well.

As best shown in FIG. 1, in one aspect the present invention includes a method for enhancing oil recovery by injecting CnF's into an injection well or series of injection wells. The CnF's then sweep oil toward a production well or series of production wells, increasing the quantity of oil recovered from the production well.

In another aspect, the present invention reduces the capillary forces trapping the oil in the reservoir rock, which allows the oil to flow. Thus, the present invention is particularly suited to reservoirs where there are high capillary forces, with oil-wet reservoirs being just one example. For instance, the Tensleep formation is one example of an oil-wet reservoir, although there are other known oil-wet reservoirs around the world. Persons skilled in the art will appreciate that the benefits afforded by the present invention extend to reservoirs with low oil recovery due to high capillary forces.

According to at least one embodiment, the CnF's are introduced at a concentration of at least 0.1%. In another embodiment, the CnFs are introduced at a concentration of at least 1%. In further embodiments, the concentration is within the range of 0.1% to 1.5% by weight.

According to at least one embodiment, the CnF's are introduced into a variety of oil-rock combinations. In further embodiments, the rock is an oil-wet rock. In exemplary embodiments, the rock is of the type found in Tensleep formations (sandstone/dolomite). Persons skilled in the art will appreciate that oil-wet rock formations similar to the type found in the Tensleep formations would have similar properties, and would respond similarly to the exemplary embodiments.

According to at least one embodiment, the present invention results in yields exceeding 50% oil recovery, including yields between 90% to 95% oil recovery. In further exemplary embodiments, the present invention yields between 60% to 90% oil recovery.

### EXAMPLE 1

A spontaneous imbibition test was conducted on Tensleep core formation in order to evaluate the CnF's potential in improving oil recovery. Imbibition is the process of one fluid displacing another fluid of lower wetting properties in a porous medium. Spontaneous imbibition occurs when no external forces drive the process; it relies on gravity and capillary forces only. The objective of this test was to evaluate the effectiveness of CnF's in increasing oil recovery.

Method. Asphaltene deposition was conducted in the lab to simulate reservoir conditions. Under reservoir conditions, oil invasion after primary drainage creates contact between oil and the solid surface. Over geologic time, asphaltenes are deposited, changing wettability toward an oil-wet condition. High capillary pressure in the smallest throats and corners of an originally water-wet porous medium will prevent complete invasion, protecting areas within the pore spaces. Additionally, oil from the Tensleep formation in the Teapot Dome field of central Wyoming was introduced into sandstone from the Tensleep formation in the Black Mountain field unit WY-3096 53 (API #4901720221) to ensure that the oil introduced into the cores was native to the formation.

Four cores from the Tensleep formation were analyzed. The cores, ranging from 1 to 1.5 inches in length and 1.5 inches in diameter, were cleaned by alternating between toluene and methanol until no residual oil discoloration was present. The clean, dry samples were then immersed in brine solution under vacuum. Once the cores were at near 100% water saturation, they were placed into a pressurization cell. Pressure was gradually increased until water saturation was lowered to approximately 20%, a process that occurred over three weeks. Finally, crude oil was introduced into the cores under vacuum, and the oil saturated cores were baked at 140 degrees Fahrenheit for six weeks to accelerate the process of asphaltene deposition.

The cores were then weighed, placed in Amott cells, and immersed in brine. Measurements of oil recovered were taken in time increments. The cores were imbibed with brine for approximately two weeks, until primary oil recovery was complete.

In the secondary recovery stage, two surfactants and the complex nano-fluid were prepared and introduced into the brine. Enhanced imbibitions followed the same procedure as the primary imbibitions. Data was gathered for three weeks.

### Data Collection

Porosity: Porosimeter and saturation methods were used to determine effective porosity values. Values ranged from 13% to 18% and 11% to 16%, respectively. Tables 1 and 2 show the results of both methods, respectively. Comparing the two methods yields approximately 2% to 5% error.

TABLE 1
Effective Porosity, Heilum Porosimeter (Tensleep)

| | Bulk Volume | | Pore Volume | |
|---|---|---|---|---|
| Core | (cm³) | Grain Volume (cm³) | (cm³) | Porosity (%) |
| 21 | 26.76 | 23.02 | 3.74 | 13.87 |
| 23 | 26.56 | 22.57 | 3.99 | 15.02 |
| 28 | 30.90 | 25.94 | 4.95 | 16.03 |
| 31 | 29.16 | 23.84 | 5.32 | 18.24 |

TABLE 2
Effective Porosity, Saturation Method (Tensleep)

| | Bulk Volume | | Pore Volume | |
|---|---|---|---|---|
| Core | (cm³) | Grain Volume (cm³) | (cm³) | Porosity (%) |
| 21 | 26.76 | 23.73 | 3.03 | 11.34 |
| 23 | 26.56 | 23.41 | 3.15 | 11.84 |
| 28 | 30.90 | 26.83 | 4.07 | 13.18 |
| 31 | 29.16 | 24.55 | 4.61 | 15.82 |

Gas permeability: Gas permeability was also measured and yielded a range from 15 to 70 mD. Table 3 shows the gas permeability results.

TABLE 3
Gas Permeability (Tensleep)

| Core | K_{g} (mD) |
|---|---|
| 21 | 19.43 |
| 23 | 15.60 |
| 28 | 36.41 |
| 31 | 68.44 |

Spontaneous Imbibition: Each core, during enhanced imbibitions, was imbibed by a different brine-surfactant recipe, shown in Table 4. The Tensleep cores had a minimal response to primary imbibition. Cumulative oil recovered ranged from 0.32 mL to 0.40 mL. The recovery rate was slow and tapered off early during the test. The initial test ran for 2 weeks before surfactants were introduced.

TABLE 4
Surfactant Composition (Tensleep)

| Core | Composition | Ratio | Concentration (% Volume) |
|---|---|---|---|
| 21 | O332:J13131 | 50:50 | 1.00 |
| 23 | O332:A771 | 40:60 | 1.00 |
| 28 | CnF | 1 | 1.00 |
| 31 | Brine | — | — |

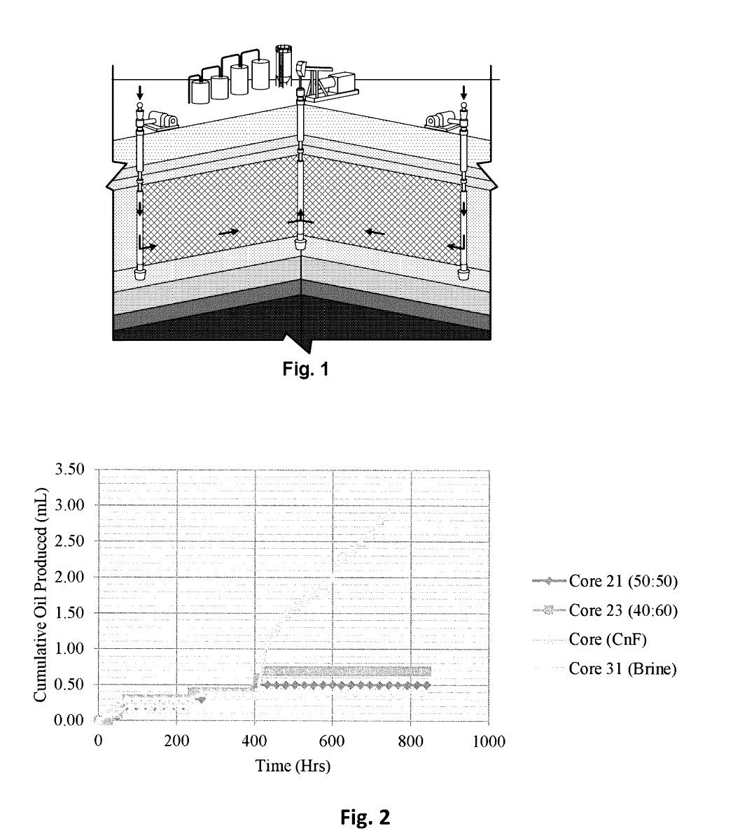

Results. FIG. 2 shows the cumulative oil recovered for primary and enhanced imbibitions of the Tensleep cores. The enhanced imbibitions tests began at 408 hours. Enhanced recovery volumes ranged from 0.05 mL to 2.50 mL. All surfactant mixtures showed improvement versus the brine. The CnF recovery significantly outperformed the surfactants and the brine alone, showing significant improvement to the recovery process.

Cumulative volumes of oil recovered as a percentage of the original oil-in-place (OOIP) of the core during each state of recovery are shown in Table 5 below.

TABLE 5
Percentage of Oil Recovered (Tensleep)

| | | Primary | | Secondary | | Totals | |
|---|---|---|---|---|---|---|---|
| | | | Re- | | Re- | | Re- |
| Core | OOIP | Volume | covered | Volume | covered | Volume | covered |
| # | (mL) | (mL) | (%) | (mL) | (%) | (mL) | (%) |
| 21 | 2.44 | 0.32 | 13.13 | 0.10 | 4.10 | 0.42 | 17.23 |
| 23 | 2.54 | 0.33 | 13.02 | 0.20 | 7.86 | 0.53 | 20.90 |
| 28 | 3.27 | 0.40 | 12.21 | 2.50 | 76.34 | 2.90 | 88.55 |
| 31 | 3.71 | 0.35 | 9.44 | 0.05 | 1.35 | 0.40 | 10.78 |

Recoveries during primary imbibitions were in the range of 9 to 13%. There was a marked improvement in recovery from the addition of chemicals in all three cores where enhanced methods were applied in the secondary imbibitions. The total recovery of the control core, using only brine, did not improve. The total recovery for the Shell surfactant treated cores was significant, ranging from 17% to 21%. The core treated with the CnF showed remarkable improvement with a total recovery of 89%.

Conclusion. Application of CnF's to oil-wet cores significantly increased oil recovery when compared with both primary recovery means (brine) and secondary recovery means (commercially available surfactants), with CnF application increasing recovery by 72% over commercially available means.

### EXAMPLE 2

In a spontaneous imbibition process, two types of porous media were analyzed with for the purpose of analyzing the behavior of oils of the type found in producing reservoirs and of the fluids injected to recover such oils in an enhanced recovery process as conditions similar to reservoir conditions. The study focused on two types of rock, pumice rock, acquired from a volcanic surface source in Arizona, and sandstone, acquired from the Tensleep formation in the Black Mountain field unit number WY-3096 53 (API #4901720221) in Wyoming's Big Horn Basin. The pumice represents a very high porosity and permeability rock that is postulated to be largely water wet, while the Tensleep sandstone represents a real reservoir, postulated to be largely oil wet.

Methods. Eleven cores of pumice were cut from samples ranging from 5 to 24 inches in diameter, and were then cut, cleaned to remove unwanted solids, and placed in an oven for 7 days to remove moisture. Finished cores ranged from 2 to 5 inches in length and were 1.5 inches in diameter. Oil extraction was not necessary as cores had not been previously exposed to oil.

Five cores from the Tensleep formation were cut from larger cored material, and were then cut and cleaned by exposing them to alternating toluene and methanol vapor until no oil residue was present. Finished cores ranged from 1 to 1.5 inches in length and 1.5 inches in diameter.

Surfactants were obtained from Shell Oil Company. The surfactants used were internal olefin sulphonates (IOS) and alcohol alkozy sulphates (AAS). One IOS was blended with one AAS in concentrations that made a clear and stable mixture while keeping total surfactant concentration to 1% or less by volume. The CnF used was MA-844W, obtained from CESI Chemical (now known as Flotek Chemical), a Flotek Industries company. MA-844W is a standalone product that consists of a micro-emulsion of surfactant, solvent, alcohol, and water. An opaque solution was created in a similar manner to the surfactants obtained from Shell.

Asphaltene deposition was conducted in the lab to simulate reservoir conditions. The clean, dry core samples were immersed in a brine solution under vacuum. Once the cores were near 100% water saturation, they were placed into a pressurization cell. Pressure was gradually increased until water saturation was lowered to approximately 20%, a process that took three weeks. Crude oil was introduced under vacuum, and the saturated cores were baked at 140 degrees Fahrenheit for six weeks to accelerate the process of asphaltene deposition.

The cores were weighed, placed in Amott cells, and immersed in reservoir brine. Measurements of oil recovered were taken in timed increments. The cores were imbibed with brine for approximately two weeks, until primary oil recovery was complete.

In the secondary recovery stage, surfactants and CnF's were prepared and introduced into the cores, and data was gathered for 3 weeks.

### Data Collection

Porosity: Pumice had an extremely high porosity, with the porosimeter yielding results ranging from 65% to 91%, and the saturation method yielding results from 76% to 84%. Tensleep core testing yielded porosimeter and saturation method porosity of 13% to 18% and 11% to 16%, respectively. Porosity results are shown in Tables 6-9 below.

TABLE 6
Effective Porosity, Helium Porosimeter (Pumice)

| | Bulk Volume | | Pore Volume | |
|---|---|---|---|---|
| Core | (cm³) | Grain Volume (cm³) | (cm³) | Porosity (%) |
| 1 | 105.71 | 14.29 | 91.42 | 86.48 |
| 4 | 97.92 | 34.26 | 63.66 | 65.02 |
| 5 | 61.75 | 5.83 | 55.92 | 90.56 |
| 6 | 71.96 | 6.88 | 65.08 | 90.44 |
| 7 | 74.76 | 9.40 | 65.35 | 87.42 |

TABLE 7
Effective Porosity, Saturation Method (Pumice)

| | Bulk Volume | | Pore Volume | |
|---|---|---|---|---|
| Core | (cm³) | Grain Volume (cm³) | (cm³) | Porosity (%) |
| 1 | 105.71 | 17.01 | 88.70 | 83.91 |
| 2 | 114.01 | 19.86 | 94.15 | 82.56 |
| 4 | 97.92 | 23.45 | 74.47 | 76.05 |
| 7 | 74.76 | 16.48 | 57.98 | 77.56 |

TABLE 8
Effective Porosity, Helium Porosimeter (Pumice)

| | Bulk Volume | | Pore Volume | |
|---|---|---|---|---|
| Core | (cm³) | Grain Volume (cm³) | (cm³) | Porosity (%) |
| 21 | 26.76 | 23.02 | 3.74 | 13.87 |
| 23 | 26.56 | 22.57 | 3.99 | 15.02 |
| 28 | 30.90 | 25.94 | 4.95 | 16.03 |
| 31 | 29.16 | 23.84 | 5.32 | 18.24 |

TABLE 9
Effective Porosity, Saturation Method (Tensleep)

| | Bulk Volume | | Pore Volume | |
|---|---|---|---|---|
| Core | (cm³) | Grain Volume (cm³) | (cm³) | Porosity (%) |
| 21 | 26.76 | 23.73 | 3.03 | 11.34 |
| 23 | 26.56 | 23.41 | 3.15 | 11.84 |
| 28 | 30.90 | 26.83 | 4.07 | 13.18 |
| 31 | 29.16 | 24.55 | 4.61 | 15.82 |

Grain size: Pumice had a high percentage of small grains within the core, with a 46% frequency of grains less than 0.075 mm in diameter. The Tensleep cores demonstrated a frequency of 67.93% of grains less than 0.150 mm in diameter, with 22.77% less than 0.075 mm in diameter. Pumice has a larger range of grain sizes than did the Tensleep formation. Grain size distribution data is shown in Tables 10 and 11.

TABLE 10
Grain Size Distribution (Pumice)

| | | Weight w/Sample | | Frequency |
|---|---|---|---|---|
| Sieve # | Sieve Weight (g) | (g) | Weight (g) | (%) |
| 30 | 81.04 | 89.45 | 8.41 | 25.01 |
| 40 | 79.09 | 81.02 | 1.93 | 5.74 |
| 50 | 78.64 | 80.38 | 1.74 | 5.18 |
| 70 | 79.45 | 80.95 | 1.50 | 4.46 |
| 100 | 75.50 | 76.67 | 1.17 | 3.48 |
| 140 | 74.70 | 76.18 | 1.48 | 4.40 |
| 200 | 74.05 | 75.63 | 1.58 | 4.70 |
| End | 73.38 | 89.00 | 15.62 | 46.54 |
| Total | | | | 99.51% |

TABLE 11
Grain Size Distribution (Tensleep)

| | | Weight w/Sample | | Frequency |
|---|---|---|---|---|
| Sieve # | Sieve Weight (g) | (g) | Weight (g) | (%) |
| 30 | 81.05 | 88.42 | 7.37 | 13.61 |
| 40 | 79.09 | 82.25 | 3.16 | 5.83 |
| 50 | 78.66 | 81.93 | 3.27 | 6.04 |
| 70 | 79.46 | 83.03 | 3.57 | 6.59 |
| 100 | 75.52 | 82.90 | 7.38 | 13.62 |
| 140 | 74.70 | 87.97 | 13.27 | 24.50 |
| 200 | 74.06 | 77.87 | 3.81 | 7.03 |
| End | 73.38 | 85.72 | 12.34 | 22.78 |
| Total | | | | 100% |

Microscopic imaging: Pumice showed large visible pores ranging from 1 to 50 μm, suggesting high porosity and permeability.

Permeability: Pumice gas permeability results yield a range of 1.9 to 2.7 Darcy, although the structural fragility of the rock made accurate results difficult to obtain. Tensleep formation cores yielded a gas permeability range from 16 to 68 mD. Permeability is shown in Tables 12 and 13.

TABLE 12
Gas Permeability (Pumice)

| Core | k_{g} (D) |
|---|---|
| 1 | 2.07 |
| 4 | 2.72 |
| 6 | 1.90 |
| 7 | 2.00 |

TABLE 13
Gas Permeability (Tensleep)

| Core | k_{g} (mD) |
|---|---|
| 21 | 19.43 |
| 23 | 15.60 |
| 28 | 36.41 |
| 31 | 68.44 |

Spontaneous imbibition: Large pore sizes resulted in successful primary imbibitions for pumice, with cumulative oil recovery ranging from 22 to 33 mL. This result is likely explained by the rock's large pore size. Enhanced recovery volumes ranged from 1.5 to 8 mL, with all surfactants showing improvement compared to the brine, but showed no clear indication of out-performance. The Tensleep cores had a low response to primary imbibition, with cumulative oil recovery ranging from 0.32 mL to 0.40 mL. Each core was imbibed by a different brine-surfactant composition for enhanced imbibition. Enhanced recovery volumes ranged from 0.04 mL to 2.50 mL. Surfactant compositions are shown in Tables 14 and 15.

TABLE 14
Surfactant Composition (Pumice)

| Core | Composition | Ratio | Concentration (% Volume) |
|---|---|---|---|
| 1 | CnF | 1 | 1.00 |
| 2 | O332:J13131 | 50:50 | 1.00 |
| 4 | O332:A771 | 40:60 | 1.00 |
| 7 | Brine | — | — |

TABLE 15
Surfactant Composition (Tensleep)

| Core | Composition | Ratio | Concentration (% Volume) |
|---|---|---|---|
| 21 | O332:J13131 | 50:50 | 1.00 |
| 23 | O332:A771 | 40:60 | 1.00 |
| 28 | CnF | 1 | 1.00 |
| 31 | Brine | — | — |

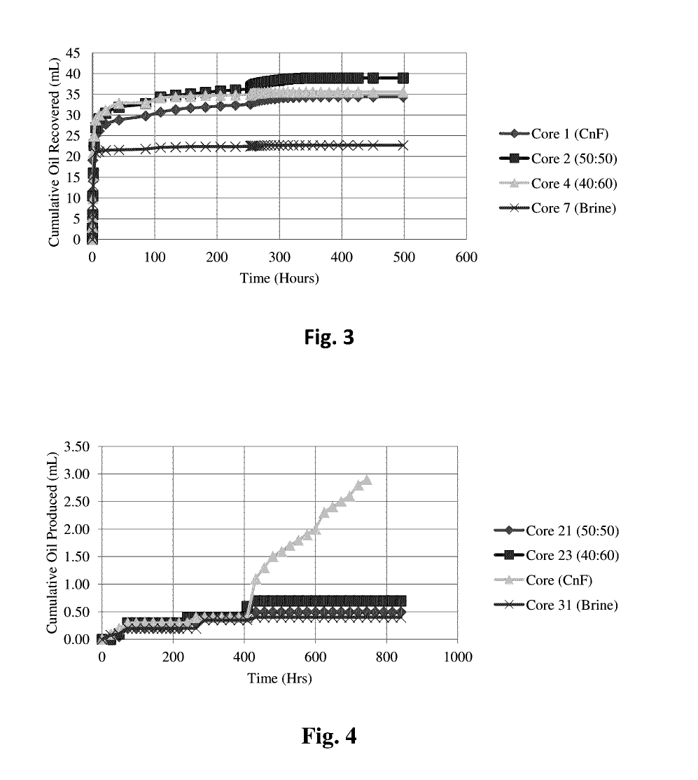

Results. FIGS. 3 and 4 show the cumulative oil recovered for primary and enhanced imbibitions of the Pumice and Tensleep cores. For the Pumice cores, enhanced imbibitions began at 253 hours. While the surfactant mixtures showed improvement over the brine alone, there was no conclusive outperformance by the CnF. For the Tensleep cores, however, the CnF recovery significantly outperformed the surfactants and the brine alone, showing significant improvement in cumulative oil recovery.

Cumulative volumes of oil recovered as a percentage of the original oil-in-place (OOIP) of the core during each state of recovery are shown in Tables 16 and 17 for both Pumice and Tensleep formation.

TABLE 16
Percentage of Oil Recovered (Pumice)

| | Bulk Volume | | Pore Volume | |
|---|---|---|---|---|
| Core | (cm³) | Grain Volume (cm³) | (cm³) | Porosity (%) |
| 21 | 26.76 | 23.02 | 3.74 | 13.87 |
| 23 | 26.56 | 22.57 | 3.99 | 15.02 |
| 28 | 30.90 | 25.94 | 4.95 | 16.03 |
| 31 | 29.16 | 23.84 | 5.32 | 18.24 |

TABLE 17
Percentage of Oil Recovered (Tensleep)

| | | Primary | | Secondary | | Totals | |
|---|---|---|---|---|---|---|---|
| | | | Re- | | Re- | | Re- |
| Core | OOIP | Volume | covered | Volume | covered | Volume | covered |
| # | (ml) | (ml) | (%) | (ml) | (%) | (ml) | (%) |
| 21 | 2.44 | 0.32 | 13 | 0.10 | 4 | 0.42 | 17 |
| 23 | 2.54 | 0.33 | 13 | 0.20 | 8 | 0.53 | 21 |
| 28 | 3.27 | 0.40 | 12 | 2.50 | 76 | 2.90 | 89 |
| 31 | 3.71 | 0.35 | 9 | 0.05 | 1 | 0.40 | 11 |

While the oil recovery results for pumice did not show a marked difference between surfactants and CnF's, the Tensleep formation showed a marked change. In the Tensleep cores, recoveries during primary imbibitions ranged from 9 to 13%. There was a marked improvement in recovery from the addition of chemicals in all three cores where enhanced methods were applied in the secondary imbibitions. While total recovery of the control core, using only brine, did not appreciably improve, the total recovery for the Shell surfactant treated cores was significant, ranging from 17% to 21%. The core treated with the CnF showed remarkable improvement with a total recovery of 89%.

Conclusion. The Tensleep formation cores benefitted greatly from the application of CnF's, producing a very high total recovery factor of more than 90%. This compares with recovery factors of 13% by water imbibitions and up to 21% with current commercial surfactants. Moreover, the improved performance is consistent, as shown in the Examples herein. These results have been repeatedly confirmed and validated through additional testing.

Although the disclosure has been described with reference to preferred embodiments, persons skilled in the art will recognize that changes may be made in form and detail without departing from the spirit and scope of the inventions disclosed herein.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. A method to enhance or improve oil recovery during oil extraction, comprising administering an effective amount of a complex nano-fluid to an injection well.

2. The method according to claim 1, wherein the complex nano-fluid comprises a micro-emulsion of a non-ionic surfactant, a solvent, water, and a co-solvent alcohol.

3. The method of claim 1, wherein the complex nano-fluid is biodegradeable and thermodynamically stable.

4. The method of claim 1, wherein the complex nano-fluid is administered at a concentration of at least 0.1 percent by weight.

5. The method of claim 1, wherein the complex nano-fluid is administered at a concentration within the range of 0.1 to 1.5 percent by weight.

6. The method of claim 1, wherein the complex nano-fluid is injected into one or more injection well.

7. The method of claim 6, wherein the one or more injection well comprises a material selected from the group containing oil-wet rocks.

8. The method of claim 7, wherein the oil-wet rock comprises sandstone and/or dolomite.

9. The method of claim 1, wherein the oil recovery is between 50 and 95 percent.

10. The method of claim 1, wherein the oil recovery is between 65 and 90 percent.

11. A method for reducing capillary forces in oil-rock, comprising administering an effective amount of a complex nano-fluid to an injection well.

12. The method according to claim 11, wherein the complex nano-fluid comprises a micro-emulsion of a non-ionic surfactant, a solvent, water, and a co-solvent alcohol.

13. The method of claim 11, wherein the complex nano-fluid is biodegradeable and thermodynamically stable.

14. The method of claim 11, wherein the complex nano-fluid is administered at a concentration of at least 0.1 percent by weight.

15. The method of claim 11, wherein the complex nano-fluid is injected into one or more injection well.

16. The method of claim 15, wherein the one or more injection well comprises a material selected from the group containing oil-wet rocks.

17. The method of claim 16, wherein the oil-wet rock is sandstone and/or dolomite.

18. The method of claim 11, wherein the oil recovery is between 50 and 95 percent.

19. The method of claim 11, wherein the oil recovery is between 65 and 90 percent.

20. A method to enhance or improve oil recovery in a single or multi-well system, comprising:
a. administering an effective amount of a complex nano-fluid to at least one injection well, and
b. sweeping the oil toward at least one production well.
